(19) United States
(12) Patent Application Publication
(10) Pub. No.: US 2026/0298967 A1
(43) Pub. Date: Oct. 1, 2026

(54) VISUALIZATION SYSTEM FOR SPATIAL VISUALIZATION

(71) Applicant: Prime Planet Energy & Solutions, Inc., Tokyo (JP)

(72) Inventor: Takashi YOSHIDA, Kakogawa-shi (JP)

(21) Appl. No.: 19/577,360

(22) Filed: Mar. 25, 2026

(30) Foreign Application Priority Data
Mar. 26, 2025 (JP) 2025-052641

(51) Int. Cl. G01P 5/00; G02F 1/1347; G02F 1/137; G03B 9/08; H04N 23/56; H04N 23/667

(52) U.S. Cl. CPC G01P 5/001; G02F 1/1347; G02F 1/137; G03B 9/08; H04N 23/56; H04N 23/667

(57) ABSTRACT

Provided is a technique of observing a gas flow during welding more accurately. A visualization system includes an image capture device, a backlight, first and second liquid crystal shutters, and an image processing device. A gap allowing a gas flow along the first and second liquid crystal shutters is provided therebetween. The image capture device acquires a first image captured under a condition where the first liquid crystal shutter is in the pattern display mode and the second liquid crystal shutter is in the transmissive mode, and a second image captured under a condition where the second liquid crystal shutter is in the pattern display mode and the first liquid crystal shutter is in the transmissive mode. The image processing device processes the first and second images to acquire an image of the gas flow flowing between the first and second liquid crystal shutters.

### CROSS REFERENCE TO RELATED APPLICATIONS

The present application claims priority from Japanese Patent Application No. 2025-052641 filed on Mar. 26, 2025, the entire contents of which are incorporated in the present specification by reference.

### BACKGROUND OF THE DISCLOSURE

### 1. Technical Field

The present invention relates to a visualization system for spatial visualization.

### 2. Background

JP 2014-044154 A discloses a fluid visualization imaging device for observing an observation object having a high light intensity or an observation object in a field having a high light intensity, such as the observation of shielding gas when performing arc welding, using a schlieren phenomenon. This fluid visualization imaging device blocks light outside an observation optical path with a diaphragm means and performs observation through a bandpass filter that transmits light having a wavelength of observation light emitted by a light source. According to JP 2014-044154 A, it is possible to observe the observation object while minimizing influence from the light originating from the observation object.

JP 2017-181067 A discloses a gas visualization system and a gas visualization method that are able to visualize a low concentration leaked gas to obtain information effective for identifying a leakage location. The gas visualization system and the gas visualization method take images of a background panel and a measurement image, calculate a difference value between a pixel value of a pixel constituting the background panel and a pixel value of a pixel constituting the measurement image for each of the pixels, and generate a difference measurement image made by difference values of the respective pixels. According to JP 2017-181067 A, it is possible to visualize a low concentration leaked gas to obtain information effective for identifying a leakage location.

JP 2012-145430 A discloses a method that enables visualization of a density gradient of a gas flow by a simple image computation and an apparatus thereof. The density gradient visualization method and apparatus place a background panel behind a measurement region and a digital camera in front of the measurement region, and calculate a difference and density gradient for each of the pixels from two images, a reference image obtained by photographing the measurement region under a condition in which there is no density distribution and a measurement image obtained by photographing the measurement region under a condition in which a density distribution occurs. According to JP 2012-145430, it is possible to visualize a gas flow with a simple apparatus configuration that does not require a large-scale optical system.

### SUMMARY

It is an intention of the present inventor to locally observe a gas flow at a given position within the gas flow with high accuracy, while in conventional schlieren methods, gas flow images in a observation direction through the space during welding are accumulated.

A visualization system for spatial visualization disclosed herein includes an image capture device, a backlight, a first liquid crystal shutter, a second liquid crystal shutter, and an image processing device. The image capture device includes an image capture surface. The backlight emits light toward the image capture surface of the image capture device. The first liquid crystal shutter has a flat plate shape and is disposed closer to the image capture device between the image capture device and the backlight. The second liquid crystal shutter has a flat plate shape and is disposed closer to the backlight than the first liquid crystal shutter between the image capture device and the backlight. The first liquid crystal shutter and the second liquid crystal shutter face each other with respect to a direction toward the image capture device from the backlight. A gap allowing a gas flow to flow along the first liquid crystal shutter and the second liquid crystal shutter is provided between the first liquid crystal shutter and the second liquid crystal shutter. Each of the first liquid crystal shutter and the second liquid crystal shutter is configured to be switchable between a transmissive mode of transmitting the light emitted from the backlight and a pattern display mode of displaying a predetermined pattern by the light emitted from the backlight. The image capture device acquires a first image and a second image. The first image is an image under a condition in which the first liquid crystal shutter is in the pattern display mode and the second liquid crystal shutter is in the transmissive mode. The second image is an image under a condition in which the second liquid crystal shutter is in the pattern display mode and the first liquid crystal shutter is in the transmissive mode. The image processing device processes the first image and the second image to acquire an image of the gas flow flowing between the first liquid crystal shutter and the second liquid crystal shutter. With such a configuration, it is possible to observe a local gas flow during welding more accurately.

### BRIEF DESCRIPTION OF THE DRAWINGS

FIG. 1 is a perspective view illustrating an electricity storage device 10.

FIG. 2 is an exploded perspective view illustrating the electricity storage device 10.

FIG. 3 is a perspective view illustrating welding of a case 11 and a sealing plate 12.

FIG. 4 is a perspective view illustrating a visualization system 100.

FIG. 5 is a plan view illustrating the visualization system 100.

FIG. 6 is a schematic view illustrating acquisition of a first image.

FIG. 7 is a schematic view illustrating acquisition of a second image.

FIG. 8 is a flowchart illustrating a spatial visualization method.

FIG. 9 is another perspective view illustrating the visualization system 100.

### DESCRIPTION OF THE EMBODIMENTS

Hereinbelow, embodiments of the technology according to the present disclosure will be described with reference to the drawings. It should be noted, however, that the embodiments illustrated herein are not intended to limit the technology disclosed herein. The drawings are depicted schematically and do not necessarily accurately depict actual objects. The features and components that exhibit the same effects are designated by the same reference symbols as appropriate, and the description thereof will not be repeated as appropriate. In the drawings, reference characters X, Y, and Z represent the front-rear axis, the lateral axis, and the vertical axis, respectively. The Y-axis is orthogonal to the X-axis. The Z-axis is orthogonal to the X-axis and the Y-axis. Reference characters F, Rr, L, R, U, and D in the drawings represent front, rear, left, right, up, and down, respectively. These directional terms are, however, merely provided for purposes in illustration and are not intended to limit the arrangements and embodiments of the electricity storage device in any way.

In the present description, the term “electricity storage device” refers to a device that is capable of charging and discharging. The electricity storage device may include a variety of batteries referred to as lithium-ion batteries and lithium secondary batteries, as well as batteries such as lithium polymer batteries and nickel-metal hydride batteries. The secondary battery refers to a battery that is capable of charging and discharging repeatedly in association with transfer of charge carriers between positive and negative electrodes. The electricity storage device may use either an electrolyte solution or a solid electrolyte. The secondary battery may be a secondary battery that uses an electrolyte solution, or may be an all-solid-state battery that uses a solid electrolyte. The electricity storage device may also include capacitors, such as electric double layer capacitors and lithium-ion capacitors.

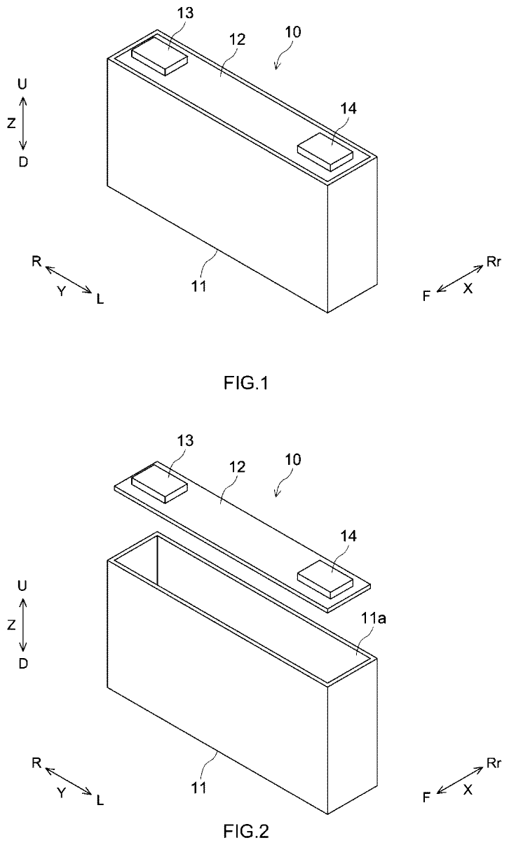

FIG. 1 is a perspective view illustrating an electricity storage device 10. FIG. 2 is an exploded perspective view illustrating the electricity storage device 10. As illustrated in FIG. 1, the electricity storage device 10 includes a case 11, a sealing plate 12, and a pair of electrode terminals 13 and 14. As illustrated in FIG. 2, the case 11 includes an opening 11a in one side surface thereof. The sealing plate 12 is a member that closes the opening 11a of the case 11. The sealing plate 12 is provided with the pair of electrode terminals 13 and 14. The pair of electrode terminals 13 and 14 are disposed at the opposite ends of the width axis Y of the sealing plate 12. Note that the method of attaching the electrode terminals 13 and 14 to the sealing plate 12 is not limited to any particular method. For example, the electrode terminals 13 and 14 may be attached to the sealing plate 12 by, for example, using a crimping process. The electrode terminals 13 and 14 may be integrally formed with the sealing plate 12. The electricity storage device 10 includes an electrode body, which is not shown in the drawings.

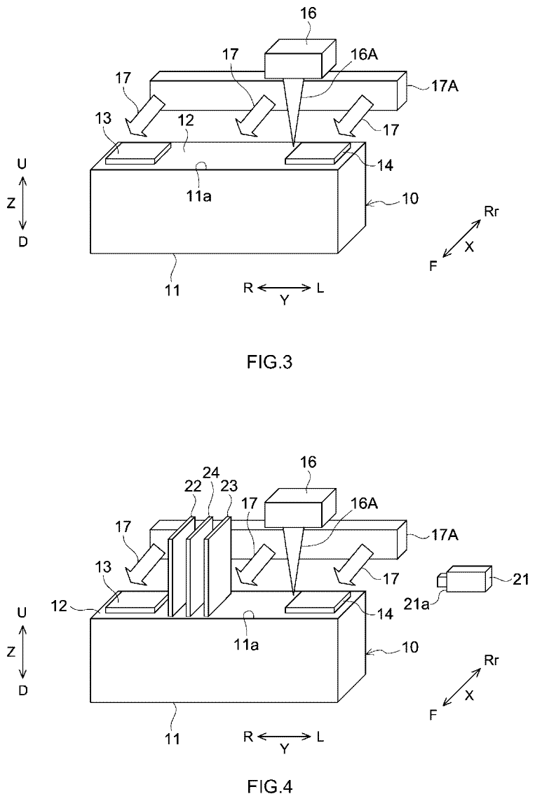

FIG. 3 is a perspective view illustrating welding of the case 11 and the sealing plate 12. FIG. 3 schematically shows the process of laser welding the sealing plate 12, which is attached to the opening 11a of the case 11, to the case 11. As illustrated in FIG. 3, in welding the case 11 and the sealing plate 12, the sealing plate 12 is first attached to the opening 11a of the case 11. Subsequently, a laser beam 16A is applied from a laser welding machine 16 to weld the opening 11a of the case 11 and the sealing plate 12 together. In this embodiment, the laser beam 16A is applied to the peripheral edge of the sealing plate 12 attached to one side surface of the opening 11a of the case 11.

At this time, the case 11 and the sealing plate 12 are welded together while blowing shielding gas 17 to a weld part from a nozzle 17A, in order to prevent oxidization of melted metal. The shield gas 17 is blown from, for example, a slit-shaped nozzle 17A formed along a longer side of the one side surface of the case 11. The direction in which the shield gas 17 is to be blown may be any of a front-rear direction, a lateral direction, and a vertical direction. FIG. 3 illustrates a state in which the shield gas 17 is blown in a front-rear direction. For the shield gas 17, it may be possible to select an appropriate gas depending on the kinds of metals to be welded and the purpose, and examples include: an inert gas such as argon, helium, and nitrogen gas; carbon dioxide; and mixture gases thereof.

When laser welding metal members to each other, shielding gas may be blown to the weld spot so that, for example, the vicinity of the weld spot can be filled with the shielding gas. This makes it possible to prevent, for example, the oxygen in the air from acting on the weld spot, to thereby prevent formation of blow holes, pinholes, spatter, or the like in the weld spot. The present inventor sought to provide good welding quality by accurately analyzing the gas flow of the shielding gas that is blown during welding. However, no method had been established for spatially analyzing the direction, velocity, and the like of the gas flow of the shielding gas that is blown during welding. For that reason, the present inventor considered a visualization system for spatial visualization as described below.

FIG. 4 is a perspective view illustrating a visualization system 100. FIG. 4 shows that the visualization system 100 is used in the process of laser welding the sealing plate 12 to the case 11 of the electricity storage device 10. FIG. 5 is a plan view illustrating the visualization system 100. FIG. 5 shows a plan view in which some of the devices and parts contained in the visualization system 100 are viewed from above the sealing plate 12 (see FIG. 4). In FIG. 5, the sealing plate 12 is not shown. As illustrated in FIG. 4, the visualization system 100 may be used to observe the condition of the shielding gas 17 in a welding step during manufacture of the electricity storage device 10.

As illustrated in FIGS. 4 and 5, the visualization system 100 includes an image capture device 21, a backlight 22, a first liquid crystal shutter 23, a second liquid crystal shutter 24, an image processing device 25, and a controller 26. A gas flow flows between the backlight 22 and the second liquid crystal shutter 24, between the second liquid crystal shutter 24 and the first liquid crystal shutter 23, and the first liquid crystal shutter 23 and the image capture device 21. Usually, the BOS schlieren method calculates accumulation of the flows in the space from the image capture device 21 to a pattern. In this embodiment, the visualization target space of the visualization system 100 is a gap 101 between the first liquid crystal shutter 23 and the second liquid crystal shutter 24. Herein, the gas flow in the gap 101 is photographed using the BOS method. The BOS method visualizes a density difference in gas, liquid (or transparent material), or the like.

The image capture device 21 captures images of a pattern displayed on the first liquid crystal shutter 23 and a pattern displayed on the second liquid crystal shutter 24. In this embodiment, the image capture device 21 acquires a first image and a second image. The details of the first image and the second image will be further described later. The image capture device 21 includes an image capture surface 21a. The image capture surface 21a is a surface that faces toward the object to be photographed, and it includes a lens. As illustrated in FIGS. 4 and 5, the image capture device 21 is disposed so that the image capture surface 21a faces toward the first liquid crystal shutter 23 and the second liquid crystal shutter 24. For the image capture device 21, an image capture device used for this kind of use, for example, may be used without any restriction. From the viewpoint of enabling more accurate visualization with the visualization system 100, the image capture device 21 may include a telecentric lens. Although not limited thereto, the image capture device 21 may use, for example, a BOS digital schlieren camera made by LaVision Inc.

The backlight 22 emits light toward the image capture surface 21a of the image capture device 21. In the embodiment shown in FIGS. 4 and 5, the backlight 22 is disposed so as to face toward the image capture surface 21a of the image capture device 21. In this embodiment, the backlight 22 is a separate component from, and is not integrated with, the second liquid crystal shutter 24. The backlight 22 and the image capture device 21 sandwich the first liquid crystal shutter 23 and the second liquid crystal shutter 24 therebetween.

The first liquid crystal shutter 23 is a flat plate-shaped panel. The first liquid crystal shutter 23 is disposed closer to the image capture device 21 between the image capture device 21 and the backlight 22. The first liquid crystal shutter 23 faces toward the image capture device 21 and is disposed spaced apart from the image capture device 21 with a given gap. For the first liquid crystal shutter 23, it is possible to use, for example, a conventionally known liquid crystal shutter that is switchable between a display mode and a transmissive mode, which will be detailed later, without any restriction.

The second liquid crystal shutter 24 is a flat plate-shaped panel. The second liquid crystal shutter 24 is disposed closer to the backlight 22 than the first liquid crystal shutter 23 between the image capture device 21 and the backlight 22. On one side thereof, the second liquid crystal shutter 24 faces toward the backlight 22 and is disposed spaced apart from the backlight 22 with a given gap. On the other side thereof, the second liquid crystal shutter 24 faces toward the first liquid crystal shutter 23 and is disposed spaced apart from the first liquid crystal shutter 23 with a given gap (gap 101 in FIG. 5). For the second liquid crystal shutter 24, it is possible to use, for example, a conventionally known liquid crystal shutter that is switchable between a display mode and a transmissive mode, which will be detailed later, without any restriction.

As illustrated in FIGS. 4 and 5, the first liquid crystal shutter 23 and the second liquid crystal shutter 24 face each other with respect to a direction toward the image capture device 21 from the backlight 22. In this embodiment, a given gap is formed respectively between each of the image capture device 21, the first liquid crystal shutter 23, the second liquid crystal shutter 24, and the backlight 22, in that order from the left of FIGS. 4 and 5. This means that a gap 101 is provided between the first liquid crystal shutter 23 and the second liquid crystal shutter 24. As illustrated in FIG. 5, the gap 101 allows a gas flow to flow along the first liquid crystal shutter 23 and the second liquid crystal shutter 24. This gas flow is a gas flow of the shielding gas 17 ejected from the nozzle 17A.

Each of the first liquid crystal shutter 23 and the second liquid crystal shutter 24 is configured to be switchable between a transmissive mode of transmitting the light emitted from the backlight 22 and a pattern display mode of displaying a predetermined pattern by the light emitted from the backlight 22. The pattern in the pattern display mode is not particularly limited to any kind of pattern as long as the pattern is suitable for obtaining a schlieren image, and examples include dot patterns, grid patterns, and striped patterns. In this embodiment, when the first liquid crystal shutter 23 is ON, the first liquid crystal shutter 23 is in the pattern display mode. When the first liquid crystal shutter 23 is OFF, the first liquid crystal shutter 23 is in the transmissive mode. When the second liquid crystal shutter 24 is ON, the second liquid crystal shutter 24 is in the pattern display mode. When the second liquid crystal shutter 24 is OFF, the second liquid crystal shutter 24 is in the transmissive mode. Switching between the pattern display mode (ON) and the transmissive mode (OFF) in the first liquid crystal shutter 23 and the second liquid crystal shutter 24 is controlled by a later-described controller 26.

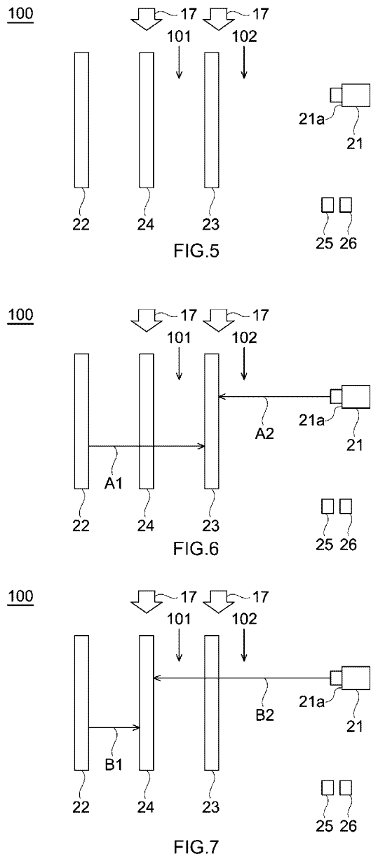

FIG. 6 is a schematic view illustrating acquisition of a first image. The first image in this embodiment is acquired in a condition in which the first liquid crystal shutter 23 is in the pattern display mode and the second liquid crystal shutter 24 is in the transmissive mode. At that time, as illustrated in FIG. 6, because the second liquid crystal shutter 24 is in the transmissive mode, the light emitted from the backlight 22 transmits through the second liquid crystal shutter 24 and enters the first liquid crystal shutter 23 (arrow A1 in FIG. 6). Because the first liquid crystal shutter 23 is in the pattern display mode, a pattern is displayed on the first liquid crystal shutter 23, which has received the incident light from the backlight 22. The image capture device 21 acquires the pattern displayed on the first liquid crystal shutter 23 as the first image (arrow A2 in FIG. 6).

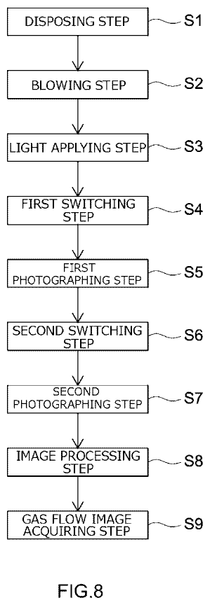

FIG. 7 is a schematic view illustrating acquisition of a second image. The second image in this embodiment is acquired in a condition in which the second liquid crystal shutter 24 is in the pattern display mode and the first liquid crystal shutter 23 is in the transmissive mode. At that time, as illustrated in FIG. 7, because the second liquid crystal shutter 24 is in the pattern display mode, a pattern is displayed on the second liquid crystal shutter 24, which has received the incident light from the backlight 22 (arrow B1 in FIG. 7). Because the first liquid crystal shutter 23 is in the transmissive mode, the image capture device 21 acquires the pattern displayed on the second liquid crystal shutter 24 as the second image (arrow B2 in FIG. 7).

The image processing device 25 (see FIGS. 5 to 7) is disposed at a given location in the visualization system 100. The image processing device 25 processes the first image and the second image to acquire an image of the gas flow flowing between the first liquid crystal shutter 23 and the second liquid crystal shutter 24 (the gap 101 herein). In this embodiment, the image processing device 25 processes the first image to acquire a first schlieren image, which originates from the gas flow in the space (gap 102 herein) between the first liquid crystal shutter 23 and the image capture device 21. The image processing device 25 processes the second image to acquire a second schlieren image, which originates from the gas flow in the space between the second liquid crystal shutter 24 and the image capture device 21. Then, the image processing device 25 obtains a difference between the first image and the second image and acquires an image of the gas flow flowing between the first liquid crystal shutter 23 and the second liquid crystal shutter 24 (the gap 101 herein). For the image processing device 25, an image processing device used for this kind of use, for example, may be used without any restriction.

The controller 26 (see FIGS. 5 to 7) is disposed at a given location in the visualization system 100. The controller 26 is configured to be communicable with the image capture device 21, the backlight 22, the first liquid crystal shutter 23, the second liquid crystal shutter 24, and the image processing device 25 so that it can perform switching between ON and OFF of each of the devices, adjustment of the output level of each of the devices, and the like. The functions of the controller 26 may be implemented by a computer that is operated according to a predetermined program. The functions of the controller 26 may be processed by an arithmetic unit [also referred to as a processor, CPU (central processing unit), or MPU (micro-processing unit)] and a memory storage device (such as a memory and a hard disk) of each computer that constitutes the controller 26. The functions of the controller 26 may be executed by sequence control using a microcomputer or the like.

In this embodiment, the controller 26 is able to cause the image capture device 21 to alternately switch between a state of acquiring the first image and a state of acquiring the second image. In this case, the controller 26 may perform switching of the objects to be photographed by the image capture device 21 and switching of the first liquid crystal shutter 23 and the second liquid crystal shutter 24 between ON and OFF. Herein, the controller 26 causes the image capture device 21 to photograph a pattern displayed on the first liquid crystal shutter 23 when the first liquid crystal shutter 23 is in the pattern display mode and the second liquid crystal shutter 24 is in the transmissive mode, to thereby acquire the first image. In contrast, the controller 26 causes the image capture device 21 to photograph a pattern displayed on the second liquid crystal shutter 24 when the first liquid crystal shutter 23 is in the transmissive mode and the second liquid crystal shutter 24 is in the pattern display mode, to thereby acquire the second image.

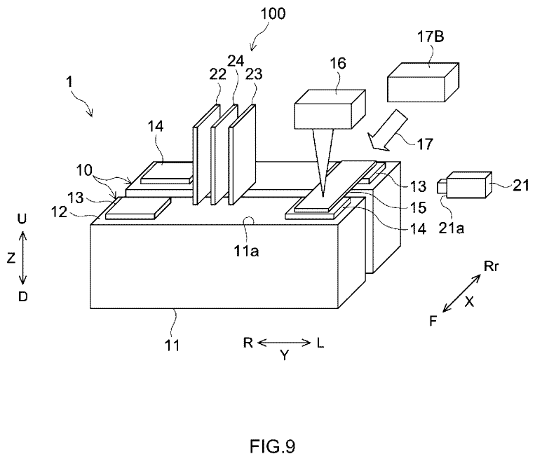

FIG. 8 is a flowchart illustrating a spatial visualization method. As illustrated in FIG. 8, this spatial visualization method includes a disposing step S1, a blowing step S2, a light applying step S3, a first switching step S4, a first photographing step S5, a second switching step S6, a second photographing step S7, an image processing step S8, and a gas flow image acquiring step S9. Hereinbelow, each of the steps of the present method will be described with reference to FIGS. 4 to 8 when appropriate.

The disposing step S1 involves disposing each of the devices in the visualization system 100 and an object to be welded (the case 11 herein) at predetermined positions. In the disposing step S1, the image capture device 21, the backlight 22, the first liquid crystal shutter 23, and the second liquid crystal shutter 24 may be disposed at predetermined positions with respect to the object to be welded. In this embodiment, the backlight 22, the first liquid crystal shutter 23, and the second liquid crystal shutter 24 may be disposed so that their planar axes are aligned along a direction in which the shielding gas 17 flows (see FIG. 3).

The blowing step S2 involves blowing the shielding gas 17 to the object to be welded. In this embodiment, the controller 26 switches ON the supply source of the shielding gas 17 in the blowing step S2. The shielding gas 17 is blown from the nozzle 17A to the object to be welded. Note that the flow rate, velocity, direction, and the like of the shielding gas 17 may be set as appropriate.

The light applying step S3 involves applying light from the backlight 22. In this embodiment, the controller 26 switches ON the backlight 22 in the light applying step S3. Note that the output power of the backlight 22 may be set as appropriate.

The first switching step S4 switches over the modes of the first liquid crystal shutter 23 and the second liquid crystal shutter 24 so that the image capture device 21 can acquire the first image. In this embodiment, the controller 26 turns ON the first liquid crystal shutter 23 to be brought into the pattern display mode and turns OFF the second liquid crystal shutter 24 to be brought into the transmissive mode in the first switching step S4.

The first photographing step S5 involves acquiring the first image. In this embodiment, in the first photographing step S5, the controller 26 causes the image capture device 21 to photograph the pattern displayed on the first liquid crystal shutter 23. Because of the necessity of obtaining differences in images, it is preferable that the first photographing step S5 be performed immediately after the first switching step S4 (that is, immediately after entering the state in which the first image can be acquired). For example, when the gas flow velocity to be observed is assumed to be 1 m/s and the computational resolution of the photographed image is 1 mm, a cycle of about 1/1000 seconds is preferable.

The second switching step S6 switches over the modes of the first liquid crystal shutter 23 and the second liquid crystal shutter 24 so that the image capture device 21 can acquire the second image. In this embodiment, the controller 26 turns OFF the first liquid crystal shutter 23 to bring it into the transmissive mode, and turns ON the second liquid crystal shutter 24 to bring it into the pattern display mode in the second switching step S6.

The second imaging step S7 involves acquiring the second image. In this embodiment, in the second photographing step S7, the controller 26 causes the image capture device 21 to photograph the pattern displayed on the second liquid crystal shutter 24. It is preferable that the second photographing step S7 be performed immediately after the second switching step S6 (that is, immediately after entering the state in which the second image can be acquired).

The image processing step S8 involves processing the first image and the second image. In this embodiment, in the image processing step S8, the controller 26 causes the image processing device 25 to process the first image and the second image to acquire the first schlieren image and the second schlieren image.

The gas flow image acquiring step S9 involves acquiring an image of the gas flow flowing between the first liquid crystal shutter 23 and the second liquid crystal shutter 24. In this embodiment, in the gas flow image acquiring step S9, the controller 26 causes the image processing device 25 to obtain a difference between the first schlieren image and the second schlieren image obtained in the image processing step S8 and to acquire an image of the gas flow flowing between the first liquid crystal shutter 23 and the second liquid crystal shutter 24 (the gap 101 herein).

Based on the gas flow image obtained in the gas flow image acquiring step S9, for example, it is also possible to reset the flow rate, velocity, direction, and the like of the shielding gas 17 that have been determined in the blowing step S2 as appropriate,

The spatial visualization method described above may be suitably applied in the state in which an object to be welded is being laser welded. In that case, the laser welding may be started, for example, after the blowing step S2. Moreover, as long as the effects of the technology disclosed herein are obtained, the sequential order of the steps in the spatial visualization method described above may be changed as appropriate, as the need arises. For example, it is possible that the second image may be acquired prior to the acquisition of the first image.

As has been described above, the visualization system 100 for spatial visualization includes the image capture device 21, the backlight 22, the first liquid crystal shutter 23, the second liquid crystal shutter 24, and the image processing device 25. The image capture device 21 includes an image capture surface 21a. The backlight 22 emits light toward the image capture surface 21a of the image capture device 21. The first liquid crystal shutter 23 has a flat plate shape and is disposed closer to the image capture device 21 between the image capture device 21 and the backlight 22. The second liquid crystal shutter 24 has a flat plate shape and is disposed closer to the backlight 22 than the first liquid crystal shutter 23 between the image capture device 21 and the backlight 22.

The first liquid crystal shutter 23 and the second liquid crystal shutter 24 face each other with respect to a direction toward the image capture device 21 from the backlight 22. The gap 101 allowing a gas flow to flow along the first liquid crystal shutter 23 and the second liquid crystal shutter 24 is provided between the first liquid crystal shutter 23 and the second liquid crystal shutter 24. Each of the first liquid crystal shutter 23 and the second liquid crystal shutter 24 is configured to be switchable between a transmissive mode of transmitting the light emitted from the backlight 22 and a pattern display mode of displaying a predetermined pattern by the light emitted from the backlight 22. The image capture device 21 acquires a first image and a second image. The first image is an image under a condition in which the first liquid crystal shutter 23 is in the pattern display mode and the second liquid crystal shutter 24 is in the transmissive mode. The second image is an image under a condition in which the second liquid crystal shutter 24 is in the pattern display mode and the first liquid crystal shutter 23 is in the transmissive mode. The image processing device 25 processes the first image and the second image to acquire an image of the gas flow flowing between the first liquid crystal shutter 23 and the second liquid crystal shutter 24 (the gap 101 herein).

The visualization system 100 with such a configuration makes it possible to acquire the first image originating from the first liquid crystal shutter 23, which constitutes a visualization target space (i.e., the gap 101), and the second image originating from the second liquid crystal shutter 24, to obtain a difference of schlieren images based on the two images. As a result, it is possible to analyze the movements of local gas flows in the visualization target space more accurately. This makes it possible to, for example, confirm that the shielding gas 17 to be blown to the object to be welded is blown onto the intended position, to thereby improve the welding quality.

The visualization system 100 may further include a controller 26. The controller 26 may be configured to cause the image capture device 21 to alternately switch between a state of acquiring the first image and a state of acquiring the second image. This allows the first image and the second image to be acquired alternately. As a result, it is possible to analyze the temporal movements of gas flows in the visualization target space more accurately over time.

The first liquid crystal shutter 23 and the second liquid crystal shutter 24 may display different patterns. Although not intended to be limited thereto, such an embodiment may include a case in which the first liquid crystal shutter 23 displays a dot pattern while the second liquid crystal shutter 24 displays a striped pattern, a case in which the first liquid crystal shutter 23 displays a vertical striped pattern while the second liquid crystal shutter 24 displays a horizontal striped pattern, and the like. This makes it possible to enhance the accuracy of difference calculation in performing image processing.

Alternatively, the first liquid crystal shutter 23 and the second liquid crystal shutter 24 may display the same pattern. Such an embodiment may also be able to appropriately achieve the effects of the technology disclosed herein.

The visualization system 100 may further include a gap adjusting mechanism (not shown) that adjusts the gap between the first liquid crystal shutter 23 and the second liquid crystal shutter 24. This makes it possible to adjust the gap between the first liquid crystal shutter 23 and the second liquid crystal shutter 24 as appropriate. As a result, it is possible to achieve the effects of the technology disclosed herein appropriately without being adversely affected by the size of the object to be welded, the welding area, and the like, for example.

The visualization system 100 may further include a support part (not shown) that supports the image capture device 21, the backlight 22, the first liquid crystal shutter 23, and the second liquid crystal shutter 24. This makes it possible to fix the relative positions of the image capture device 21, the backlight 22, the first liquid crystal shutter 23, and the second liquid crystal shutter 24. As a result, it is possible to analyze the gas flows in different locations as needed by simply moving the position of the support part, thereby achieving higher accuracy of the analysis.

The backlight 22 may include a flat-shaped light emitting surface covering a surface of the second liquid crystal shutter 24 on which the pattern is displayed. The light emitting surface may be fitted on a surface thereof that is opposite to the surface thereof that faces the first liquid crystal shutter 23. This enables light to be applied over the entire surface of the second liquid crystal shutter. This allows the area in which the gas flow is photographed to be larger.

The image capture device 21 may also include a telecentric lens. This makes it possible to acquire clearer images. As a result, it is possible to enhance the accuracy of difference calculation.

Hereinabove, some embodiments of the technology disclosed herein have been described. However, the technology disclosed herein is not limited to the embodiments described above. The technology disclosed herein may include various modifications and alterations as long as the effects of the techniques disclosed herein can be obtained.

For example, in the foregoing embodiments, the backlight 22 and the second liquid crystal shutter 24 are separate components. However, the technology disclosed herein is not limited thereto. The backlight 22 and the second liquid crystal shutter 24 may be an integrated component. When this is the case, there may be no gap between the backlight 22 and the second liquid crystal shutter 24.

Furthermore, in the foregoing embodiments, the visualization system 100 is used in welding the case 11 and the sealing plate 12 together. However, the technology disclosed herein is not limited thereto. It is also possible that the visualization system 100 may be used when constructing an electricity storage module. FIG. 9 is a perspective view illustrating the visualization system 100. FIG. 9 shows that the visualization system 100 is used for constructing an electricity storage module 1. As illustrated in FIG. 9, in the electricity storage module 1, a plurality of electricity storage devices 10 are arrayed so that the electrode terminals 13 and the electrode terminals 14 that are attached to the sealing plates 12 are adjacent to each other. A bus bar 15 is bridged across the electrode terminal 13 and the electrode terminal 14. A laser beam 16A is applied to the bus bar 15 by a laser welding machine 16, to weld together the bus bar 15, the electrode terminal 13, and the electrode terminal 14. During laser welding, a shielding gas 17 is blown from a nozzle 17B. In the embodiment shown in FIG. 9, the backlight 22, the first liquid crystal shutter 23, and the second liquid crystal shutter 24 may be disposed so that their planar axes are aligned along the direction in which the shielding gas 17 is blown.

The technology disclosed herein encompasses the contents described in the following items.

### Item 1

A visualization system for spatial visualization, including:
an image capture device including an image capture surface;
a backlight for emitting light toward the image capture surface of the image capture device;
a first liquid crystal shutter being in a flat plate shape and disposed closer to the image capture device between the image capture device and the backlight;
a second liquid crystal shutter being in a flat plate shape and disposed closer to the backlight than the first liquid crystal shutter between the image capture device and the backlight; and
an image processing device, wherein:
the first liquid crystal shutter and the second liquid crystal shutter facing each other with respect to a direction toward the image capture device from the backlight;
a gap is formed between the first liquid crystal shutter and the second liquid crystal shutter, the gap allowing a gas flow to flow along the first liquid crystal shutter and the second liquid crystal shutter;
each of the first liquid crystal shutter and the second liquid crystal shutter is configured to be switchable between a transmissive mode of transmitting the light emitted from the backlight and a pattern display mode of displaying a predetermined pattern by the light emitted from the backlight;
the image capture device acquires:
   a first image captured under a condition in which the first liquid crystal shutter is in the pattern display mode and the second liquid crystal shutter is in the transmissive mode; and
   a second image captured under a condition in which the second liquid crystal shutter is in the pattern display mode and the first liquid crystal shutter is in the transmissive mode; and
the image processing device processes the first image and the second image to acquire an image of the gas flow flowing between the first liquid crystal shutter and the second liquid crystal shutter.

### Item 2

The visualization system for spatial visualization according to item 1, further including:
a controller, and wherein
the controller is configured to cause the image capture device to alternately switch between a state of acquiring the first image and a state of acquiring the second image.

### Item 3

The visualization system for spatial visualization according to item 1 or 2, wherein the first liquid crystal shutter and the second liquid crystal shutter display different patterns.

### Item 4

The visualization system for spatial visualization according to any one of items 1 through 3, further including a gap adjusting mechanism adjusting a gap between the first liquid crystal shutter and the second liquid crystal shutter.

### Item 5

The visualization system for spatial visualization according to any one of items 1 through 4, further including a support part supporting the backlight, the first liquid crystal shutter, and the second liquid crystal shutter.

### Item 6

The visualization system for spatial visualization according to any one of items 1 through 5, wherein:
the backlight includes a flat-shaped light emitting surface covering a surface of the second liquid crystal shutter on which the pattern is displayed; and
the light emitting surface is fitted on a surface of the backlight that is opposite to a surface of the backlight that faces the first liquid crystal shutter.

### Item 7

The visualization system for spatial visualization according to items 1 through 6, wherein the image capture device includes a telecentric lens.

What is claimed is:

1. A visualization system for spatial visualization, the system comprising:
an image capture device including an image capture surface;
a backlight for emitting light toward the image capture surface of the image capture device;
a first liquid crystal shutter having a flat plate shape and disposed closer to the image capture device between the image capture device and the backlight;
a second liquid crystal shutter having a flat plate shape and disposed closer to the backlight than the first liquid crystal shutter between the image capture device and the backlight; and
an image processing device, wherein:
the first liquid crystal shutter and the second liquid crystal shutter facing each other with respect to a direction toward the image capture device from the backlight;
a gap is formed between the first liquid crystal shutter and the second liquid crystal shutter, the gap allowing a gas flow to flow along the first liquid crystal shutter and the second liquid crystal shutter;
each of the first liquid crystal shutter and the second liquid crystal shutter is configured to be switchable between a transmissive mode of transmitting the light emitted from the backlight and a pattern display mode of displaying a predetermined pattern by the light emitted from the backlight;
the image capture device acquires:
a first image captured under a condition in which the first liquid crystal shutter is in the pattern display mode and the second liquid crystal shutter is in the transmissive mode; and
a second image captured under a condition in which the second liquid crystal shutter is in the pattern display mode and the first liquid crystal shutter is in the transmissive mode; and
the image processing device processes the first image and the second image to acquire an image of the gas flow flowing between the first liquid crystal shutter and the second liquid crystal shutter.

2. The visualization system for spatial visualization according to claim 1, further comprising:
a controller, and wherein
the controller is configured to cause the image capture device to alternately switch between a state of acquiring the first image and a state of acquiring the second image.

3. The visualization system for spatial visualization according to claim 1, wherein the first liquid crystal shutter and the second liquid crystal shutter display different patterns.

4. The visualization system for spatial visualization according to claim 1, further comprising a gap adjusting mechanism adjusting a gap between the first liquid crystal shutter and the second liquid crystal shutter.

5. The visualization system for spatial visualization according to claim 1, further comprising a support part supporting the backlight, the first liquid crystal shutter, and the second liquid crystal shutter.

6. The visualization system for spatial visualization according to claim 1, wherein:
the backlight includes a flat-shaped light emitting surface covering a surface of the second liquid crystal shutter on which the pattern is displayed; and
the light emitting surface is fitted on a surface of the backlight that is opposite to a surface of the backlight that faces the first liquid crystal shutter.

7. The visualization system for spatial visualization according to claim 1, wherein the image capture device includes a telecentric lens.
